(19) United States
(12) Patent Application Publication
(10) Pub. No.: US 2019/0042897 A1
(43) Pub. Date: Feb. 7, 2019

(54) Two-dimensional Symbols For Machine Learning Of Written Chinese Language Using "pinyin" Letters

(71) Applicant: GYRFALCON TECHNOLOGY INC., Milpitas, CA (US)

(72) Inventors: Lin Yang, Milpitas, CA (US); Patrick Z. Dong, San Jose, CA (US)

(21) Appl. No.: 15/683,716

(22) Filed: Aug. 22, 2017

Related U.S. Application Data
(60) Provisional application No. 62/541,081, filed on Aug. 3, 2017.

(51) Int. Cl. G06K 9/66; G06K 9/72; G06K 9/46; G06N 3/08; G06N 3/04

(52) U.S. Cl. CPC G06K 9/66; G06K 9/72; G06K 2209/013; G06N 3/08; G06N 3/0481; G06K 9/4628

(57) ABSTRACT

Two-dimensional symbol for facilitating machine learning of written Chinese language using “pinyin” letters is disclosed. The two-dimensional symbol comprises a matrix of N×N pixels of data containing a “super-character” that represents specific form and meaning of written Chinese language. Each pixel contains a K-bit binary number for representing a Chinese “pinyin” letter. The matrix is partitioned into sections with each section being so sized for storing an identical training set of at least Y Chinese characters in a specific order maintained by a Cellular Neural Networks (CNN) based computing system. As a result, a first section contains first P rows of the matrix while remaining sections contain respective subsequent next P rows of the matrix. Each pixel is either “on” or “off”. One Chinese character is recognized out of the training set in each section, when corresponding consecutive pixels are “on”, where N, K, P and Y are positive integers.

### CROSS-REFERENCE TO RELATED APPLICATIONS

This application claims priority from a co-pending U.S. Provisional Patent Application Ser. No. 62/541,081, entitled “Two-dimensional Symbol For Facilitating Machine Learning Of Natural Languages Having Logosyllabic Characters” filed on Aug. 3, 2017. The contents of which are incorporated by reference in its entirety for all purposes.

### FIELD

The invention generally relates to the field of machine learning and more particularly to two-dimensional symbols for facilitating machine learning of written Chinese language using “pinyin” letters.

### BACKGROUND

Written Chinese language have been traced back around 1000 BC in forms of ancient Chinese characters, which evolve over time and become the modern Chinese characters (i.e., Hanzi in Chinese “pinyin” system). Chinese characters are logosyllabic; that is, a character generally represent one syllable of spoken Chinese and may be word of its own or a part of polysyllabic word. The characters themselves are often composed of parts that may represent physical objects, abstract notions, or pronunciation. Literacy requires the memorization of a great many characters (e.g., about three- to four-thousands characters). The large number of Chinese characters has in part led to the adoption of Latin alphabets as an auxiliary means of representing Chinese (i.e., Chinese “pinyin” system). Standardization of Chinese character set has also been evolving over the past decades. The latest standard is referred to as GB18030, which is a Chinese government standard as “Information technology—Chinese coded character set” for defining entire Chinese character set. GB18030 defines the required language and character support for software.

Traditionally, written Chinese have been learned and mastered with rote learning techniques such as memorization with repetition. Students generally learn the written Chinese language from individual characters, to compound phrases, idioms, proverbs, sentences, poems, paragraphs, articles (i.e., written works), etc.

Machine learning is an application of artificial intelligence. In machine learning, a computer or computing device is programmed to think like human beings so that the computer may be taught to learn on its own. The development of neural networks has been key to teaching computers to think and understand the world in the way human beings do. One particular implementation is referred to as Cellular Neural Networks or Cellular Nonlinear Networks (CNN) based computing system. CNN based computing system has been used in many different fields and problems including, but not limited to, image processing.

### SUMMARY

This section is for the purpose of summarizing some aspects of the invention and to briefly introduce some preferred embodiments. Simplifications or omissions in this section as well as in the abstract and the title herein may be made to avoid obscuring the purpose of the section. Such simplifications or omissions are not intended to limit the scope of the invention.

Two-dimensional symbols for facilitating machine learning of written Chinese language are disclosed. According to one aspect of the invention, a two-dimensional symbol comprises a matrix of N×N pixels of data containing a “super-character” that represents specific form and meaning of written Chinese language. Each pixel contains a K-bit binary number for representing a Chinese “pinyin” letter. The matrix is partitioned into a number of sections with each section being so sized for storing an identical training set of at least Y Chinese characters in a specific order maintained by a Cellular Neural Networks or Cellular Nonlinear Networks (CNN) based computing system. As a result, a first section contains first P rows of the matrix while remaining sections contain respective subsequent next P rows of the matrix. N, K, P and Y are positive integers. Each pixel is either “on” or “off”. A particular Chinese character is recognized out of the training set in each section, when corresponding consecutive pixels are “on”.

The “super-character” represents specific form and meaning of written Chinese language including, for example, compounded phrases, idioms, proverbs, poems, passages, sentences, articles (i.e., written works), etc.

One of the objectives, features and advantages of the invention is to use a two-dimensional symbol for representing more than individual ideogram, logosyllabic script or character (e.g., Chinese character). Such a two-dimensional symbol facilitates a CNN based computing system to learn the meaning of a specific combination of a plurality of Chinese characters contained in a “super-character” using image processing techniques, e.g., convolutional neural networks, recurrent neural networks, etc.

Other objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIG. 1 is a diagram illustrating an example two-dimensional symbol comprising a matrix of N×N pixels of data containing a “super-character” for facilitating machine learning of written Chinese language in accordance with one embodiment of the invention;

FIG. 2 is a diagram showing a group of Chinese “pinyin” letters, each of which is represented by data contained in one pixel in the two-dimensional symbol of FIG. 1, according to an embodiment of the invention;

FIGS. 3A-3B collectively are a table showing all combinations of Chinese “pinyin” letters that used in the two-dimensional symbol of FIG. 1;

FIG. 4 is a diagram showing an example two-dimensional symbol partitioned into a number of sections for storing an identical training set of Chinese characters in a specific order based on Chinese “pinyin” letters, according to an embodiment of the invention;

FIG. 5 is a diagram showing an example set of Chinese characters in a specific order to be contained in each of the sections shown in FIG. 4, according to an embodiment of the invention; and

FIG. 6 is block diagram illustrating an example Cellular Neural Networks or Cellular Nonlinear Networks (CNN) based computing system for machine learning of written Chinese language contained in a two-dimensional symbol according to one embodiment of the invention.

### DETAILED DESCRIPTIONS

In the following description, numerous specific details are set forth in order to provide a thorough understanding of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or circuits representing one or more embodiments of the invention do not inherently indicate any particular order nor imply any limitations in the invention. Used herein, the terms “vertical”, “horizontal”, “left”, “right”, “upper”, “lower”, “column”, “row” are intended to provide relative positions for the purposes of description, and are not intended to designate an absolute frame of reference.

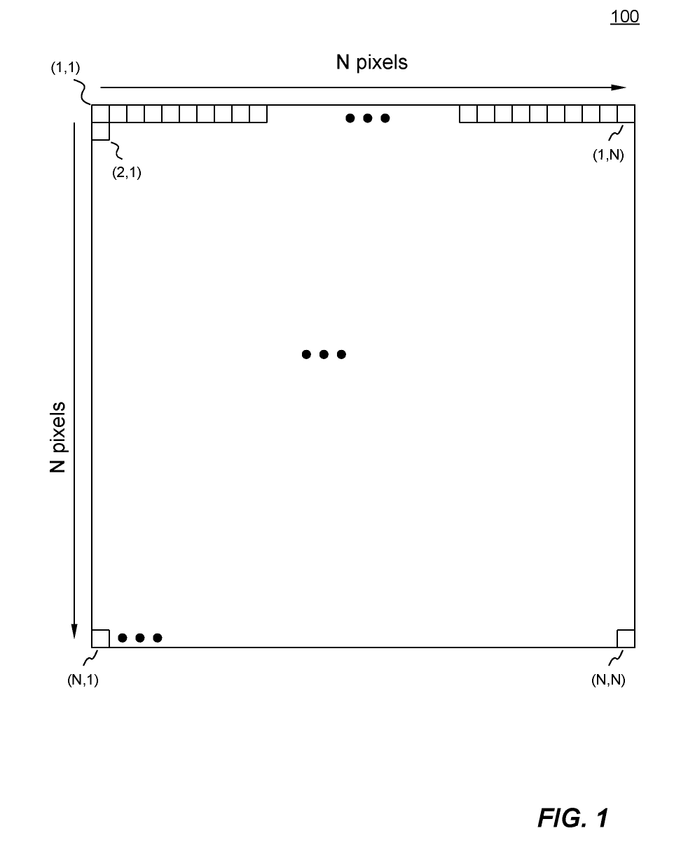

Embodiments of the invention are discussed herein with reference to FIGS. 1-6. However, those skilled in the art will readily appreciate that the detailed description given herein with respect to these figures is for explanatory purposes as the invention extends beyond these limited embodiments.

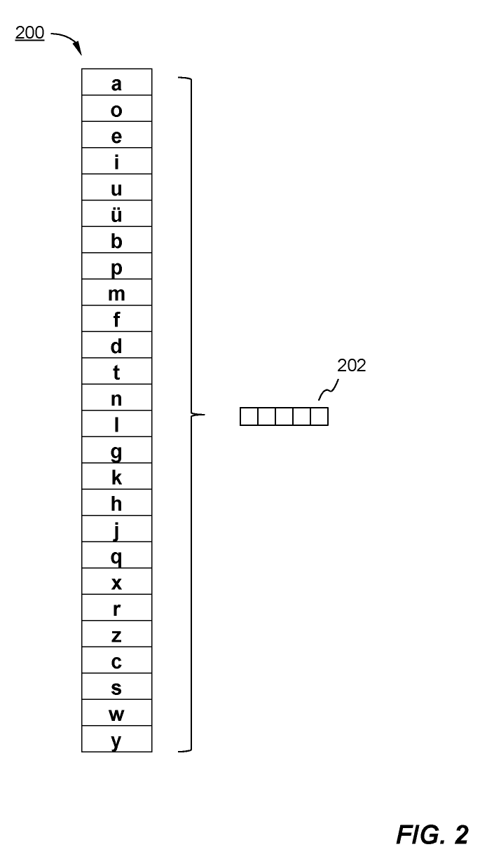

Referring first to FIG. 1, it is shown a diagram showing an example two-dimensional symbol 100 for facilitating machine learning of written Chinese language in accordance with one embodiment of the invention. The two-dimensional symbol 100 comprises a matrix of N×N pixels (i.e., N columns by N rows) of data containing a “super-character” that represents specific form and meaning of written Chinese language. Pixels are ordered with row first and column second as follows: (1,1), (1,2), (1,3), . . . (1,N), (2,1), . . . , (N,1), . . . (N,N). N is a positive integer or whole number, for example in one embodiment, N is equal to 224. Each pixel contains a K-bit binary number 202 for representing one of the group of Chinese “pinyin” letters 200 as shown in FIG. 2. K is a positive integer or whole number, for example in one embodiment, K is equal to 5. A 5-bit binary number can represent up to 2⁵=32 different states which are large enough to cover entire group of Chinese “pinyin” letters 200.

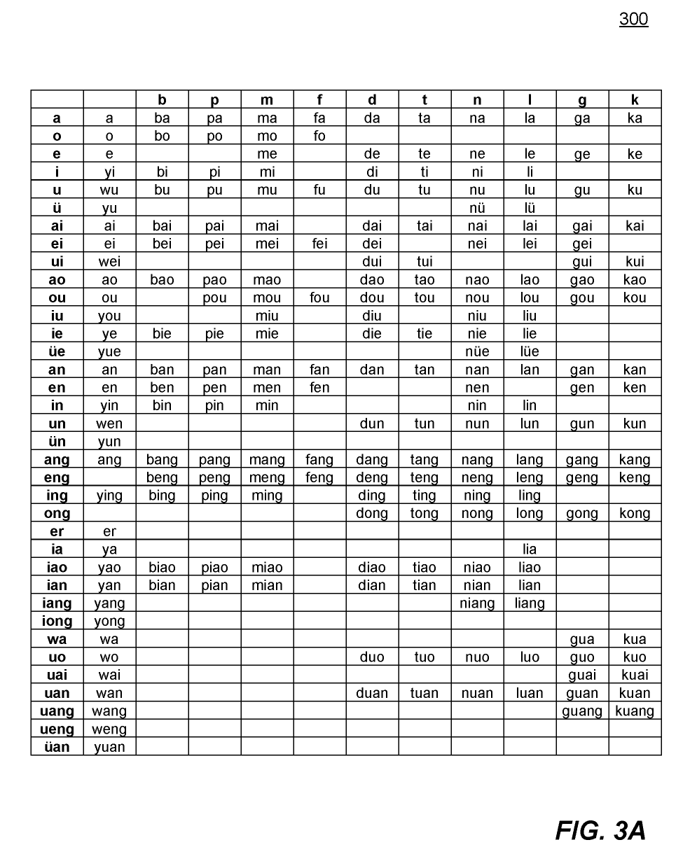

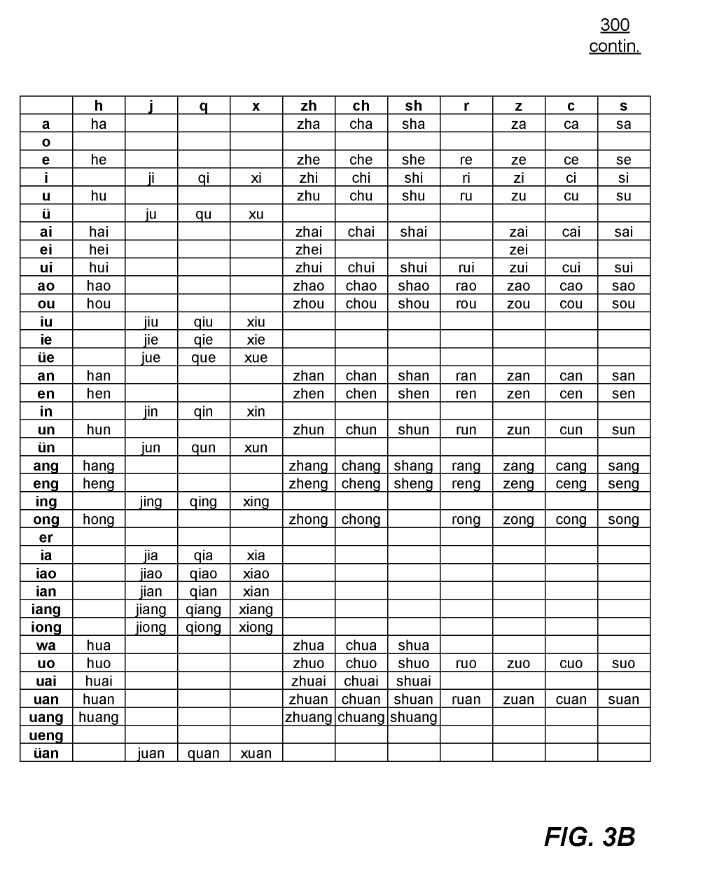

The Chinese “pinyin” system uses Latin letters to represent pronunciation sounds of Chinese characters. FIGS. 3A-3B collectively show a table 300 of all possible combinations of pronunciation of all Chinese characters.

Each pixel of data 202 can be shown or displayed with a specific color or grayscale. Also each pixel of data 202 can be turned to either “on” or “off”.

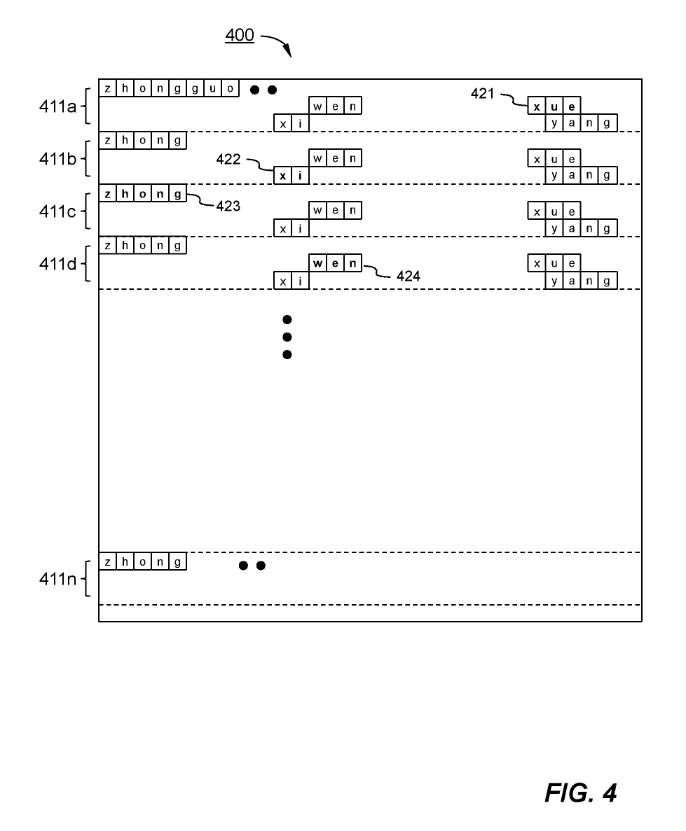

For facilitating machine learning, FIG. 4 shows a two-dimensional symbol 400 is partitioned into a number of sections 411a-411n. Each section 411a-411n is configured for storing an identical training set of at least Y Chinese characters. As a result, the first section 411a contains first P rows of the matrix in the two-dimensional symbol 400. The second section 411b contains subsequent next P rows and the third section 411c contains the following next P rows, etc. Y and P are positive integers or whole numbers. In one embodiment, Y is equal to 1000 and P is equal to 20. For illustration simplicity and clarity, only few Chinese characters instead of the entire training set are shown.

Before the contents are recognized, the two-dimensional symbol 400 is a simply a matrix of N×N pixels with certain pixels “on” and others “off”. The “super-character” contains at least two Chinese characters that represent specific form and meaning of written Chinese language including, but not necessarily limited to, compounded phrases, idioms, proverbs, passages, sentences, poems. In another embodiment, when there is only one character in a two-dimensional symbol, the “super-character” contains one Chinese character.

In FIG. 4, one particular Chinese character is recognized out of the training set in each section 411a-411n. To recognize the particular Chinese character, all pixels except those representing the recognized Chinese character are “off”. In other words, only one group of consecutive pixels can be turned “on” in each section. Pixels in a section can be all “off” in certain situations, which means there is no character in that section. To demonstrate this technique, bold face letters shown in FIG. 4 represent the “on” pixels, other pixels are “off”. In the example shown in FIG. 4, Chinese characters represented by “xue” 421, “xi” 422, “zhong” 423 and “wen” 424 are recognized in sections 411a-d, respectively.

All of the recognized Chinese characters in the two-dimensional symbol 400 represent specific meaning (i.e., “xue”, “xi”, “zhong” and “wen”, which means learning Chinese language) instead of a group of unrelated Chinese characters. In one embodiment, the specific meaning includes, but is not limited to, compound phrase, idioms, proverbs, etc. These recognized Chinese characters may not necessarily be in any particular order. In other words, the order of the recognized Chinese characters in each two-dimensional symbol 400 is arbitrary.

The “super-character” may contain more than one meanings in certain instances. “Super-character” can tolerate certain errors that can be corrected with error-correction techniques. In other words, the pixels represent Chinese “pinyin” letters do not have to be exact. The errors may have different causes, for example, data corruptions, during data retrieval, etc.

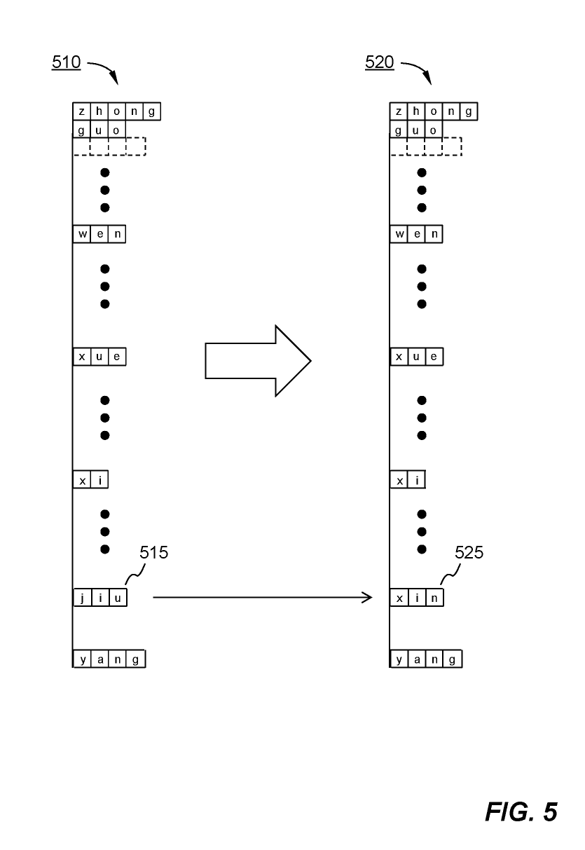

The training set can be initially established in many techniques, for example, inputted manually or generated with a default setting. An example set 510 is shown in FIG. 5. For illustration simplicity, only few pixels are shown in the example set 510. The training set 510 is managed by a Cellular Neural Networks or Cellular Nonlinear Networks (CNN) based computing system 800. In other words, the training set 510 can be trained or evolved over time with a set of machine learning rules. As an example shown in FIG. 5, the old or existing set 510 may be updated to a new set 520 with one modification—pixels “jiu” (means old) 515 to pixels “xin” (means new) 525. In certain instances, “super-character” such as Chinese idiom, proverb, compound phrase may be in a particular area of the written Chinese language. The particular area may include, but is not limited to, certain folk stories, historic periods, etc.

“Super-character” is extracted out of the matrix (e.g., the example two-dimensional symbol 400 of FIG. 4) in a Cellular Neural Networks or Cellular Nonlinear Networks (CNN) using image processing techniques, e.g., convolutional neural networks, recurrent neural networks, etc.

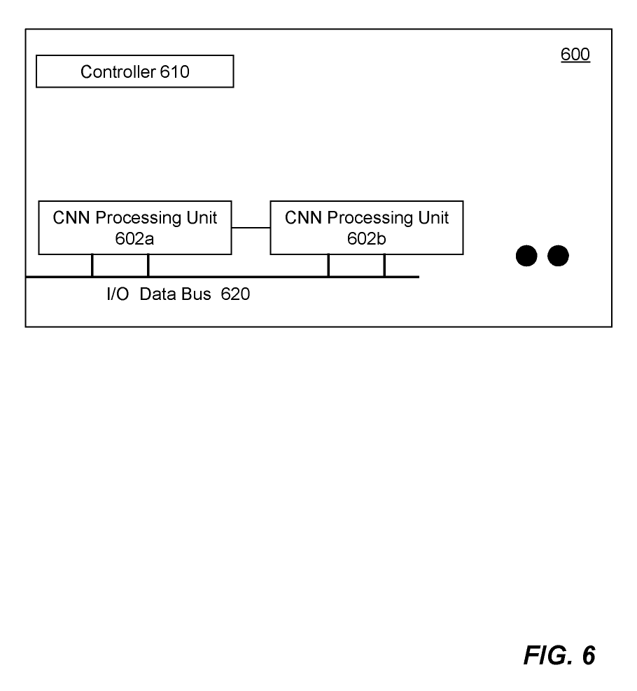

Referring now to FIG. 6, it is shown a block diagram illustrating an example Cellular Neural Networks or Cellular Nonlinear Networks (CNN) based computing system 800 for machine leaning of written Chinese language contained in a two-dimensional symbol, e.g., the example two-dimensional symbol 400 of FIG. 4.

The CNN based computing system 600 may be implemented on integrated circuits as a digital semi-conductor chip (e.g., a silicon substrate) and contains a controller 610, and a plurality of CNN processing units 602a-602b operatively coupled to at least one input/output (I/O) data bus 620. Controller 610 is configured to control various operations of the CNN processing units 602a-602b, which are connected in a loop with a clock-skew circuit.

In one embodiment, each of the CNN processing units 602a-602b is configured for processing imagery data (e.g., the example two-dimensional symbol 400 of FIG. 4). The training set of Y Chinese characters may be stored in the CNN based computing system 600.

In another embodiment, the CNN based computing system is a digital integrated circuit that can be extendable and scalable. For example, multiple copies of the digital integrated circuit may be implemented on a single semi-conductor chip.

Although the invention has been described with reference to specific embodiments thereof, these embodiments are merely illustrative, and not restrictive of, the invention. Various modifications or changes to the specifically disclosed example embodiments will be suggested to persons skilled in the art. For example, whereas the two-dimensional symbol has been described and shown with a specific example of a matrix of 224×224 pixels, other sizes may be used for achieving substantially similar objections of the invention. Additionally, whereas at 1000 Chinese characters in a training set has been shown and described, other number of Chinese characters may be used for achieving the same. Furthermore, the Chinese “pinyin” letters shown in the examples are arbitrarily selected, other “pinyin” letters may be used for achieving objectives of the invention. In summary, the scope of the invention should not be restricted to the specific example embodiments disclosed herein, and all modifications that are readily suggested to those of ordinary skill in the art should be included within the spirit and purview of this application and scope of the appended claims.

What is claimed is:

1. A two-dimensional symbol for facilitating machine learning of written Chinese language comprising:
a matrix of N×N pixels of data containing a “super-character” that represents specific form and meaning of written Chinese language, each pixel containing a K-bit binary number for representing a Chinese “pinyin” letter; and
the matrix being partitioned into a plurality of sections with each section being so sized for storing an identical training set of at least Y Chinese characters in a specific order, as a result, a first section contains first P rows of the matrix while remaining sections contain respective subsequent next P rows of the matrix, where N, K, P and Y are positive integers.

2. The two-dimensional symbol of claim 1, wherein N is 224, K is 5, P is 20 and Y is 1000.

3. The two-dimensional symbol of claim 2, wherein said each pixel is either “on” or “off”.

4. The two-dimensional symbol of claim 3, wherein said each pixel correlates to a particular color or grayscale in accordance with the K-bit binary number.

5. The two-dimensional symbol of claim 3, wherein the particular Chinese character is recognized out of the training set in said each section, when corresponding consecutive pixels are “on”.

6. The two-dimensional symbol of claim 2, wherein the “super-character” comprises at least two Chinese characters.

7. The two-dimensional symbol of claim 2, wherein the “super-character” comprises a Chinese compounded phrase.

8. The two-dimensional symbol of claim 2, wherein the “super-character” comprises a Chinese idiom.

9. The two-dimensional symbol of claim 2, wherein the “super-character” comprises a Chinese proverb.

10. The two-dimensional symbol of claim 2, wherein the “super-character” comprises a Chinese sentence.

11. The two-dimensional symbol of claim 2, wherein the “super-character” comprises a Chinese passage.

12. The two-dimensional symbol of claim 2, wherein the “super-character” comprises a Chinese article.

13. The two-dimensional symbol of claim 1, wherein the “super-character” is recognized in a Cellular Neural Networks or Cellular Nonlinear Networks (CNN) based computing system via an image processing technique.

14. The two-dimensional symbol of claim 13, wherein the image processing technique comprises an algorithm based on convolution neural networks.

15. The two-dimensional symbol of claim 14, wherein the CNN based computing system comprises a semi-conductor chip containing digital circuits dedicated for performing the convolution neural networks algorithm.

16. The two-dimensional symbol of claim 13, wherein the training set is managed by the CNN based computing system.

17. The two-dimensional symbol of claim 16, wherein the training set is initially generated or inputted either manually or with a default setting.

18. The two-dimensional symbol of claim 16, wherein the training set is updated by the CNN based computing system with a set of machine learning rules.

19. The two-dimensional symbol of claim 18, wherein the training set of machine learning rules comprises certain criteria for recognizing Chinese idioms, proverbs and compound phrases in a particular area of the written Chinese language.

20. The two-dimensional symbol of claim 13, wherein the specific order is maintained by the CNN based computing system.
